(19) United States
(12) Patent Application Publication
(10) Pub. No.: US 2016/0086135 A1
(43) Pub. Date: Mar. 24, 2016

(54) EVALUATION APPARATUS, EVALUATION METHOD AND EVALUATION SYSTEM FOR EVALUATING EVALUATION TARGET PERSON

(71) Applicant: NEC Corporation, Tokyo (JP)

(72) Inventors: Yasuyuki TOMONAGA, Tokyo (JP); Nobutatsu NAKAMURA, Tokyo (JP)

(73) Assignee: NEC CORPORATION, Tokyo (JP)

(21) Appl. No.: 14/857,169

(22) Filed: Sep. 17, 2015

(30) Foreign Application Priority Data
Sep. 18, 2014 (JP) 2014-190010

(51) Int. Cl. G06Q 10/10

(52) U.S. Cl. CPC G06Q 10/1053

(57) ABSTRACT

The present invention provides an evaluation apparatus and an evaluation method which can evaluate an evaluation target person without difficulty, based on data regarding the evaluation target person. An evaluation apparatus 1 includes a condition determining unit 11 and an evaluation unit 12. On the basis of first data D1, which includes a feature quantity of information generated according to an activity of a first evaluation target person, and an evaluation value E1 of each first evaluation target person, the condition determining unit 11 determines a condition CO which associates the first data D1 and the evaluation value E1. On the basis of second data D2, which includes a feature quantity of information generated according to an activity of a second evaluation target person, and the condition CO, the evaluation unit 12 calculates an evaluation value E2 of the second evaluation target person.

This application is based upon and claims the benefit of priority from Japanese Patent Application No. 2014-190010, filed on Sep. 18, 2014, the disclosure of which is incorporated herein in its entirety by reference.

### TECHNICAL FIELD

The present invention relates to an evaluation apparatus, an evaluation method and an evaluation system for evaluating an evaluation target person.

### BACKGROUND ART

In a company, it is very important to enhance performance of an employee (constituent member) and to employ an applicant for a position (hereinafter, referred as “job applicant”), who may achieve high performance after being employed by the company, for the development of the company. Therefore, recently, an technology, which supports a personnel (human resource) system of a company from an aspect of information system, has been proposed.

For example, PTL 1 discloses an apparatus (transition condition presenting apparatus) which presents a condition to conduct (lead) a constituent member (for example, an employee) for success. The transition condition presenting apparatus classifies each of constituent members of a group, who is an analysis target, into any one of a successful person, a non-successful person and a middle class person, and generates evaluation information. The transition condition presenting apparatus directs the constituent member to take an aptitude test. On the basis of the generated evaluation information and information of a result of the aptitude test, the transition condition presenting apparatus executes the decision tree analysis which is a statistical analysis method. And the transition condition presenting apparatus generates a success model. Then, the transition condition presenting apparatus calculates a ratio of conformity of each constituent member to the successful person specified by the model. As mentioned above, according to PTL 1, it is expected to calculate the ratio of partial conformance of a person, who is not evaluated as successful person, to the success model. And furthermore, according to PTL 1, it is expected to derive a necessary condition to conform to the success model completely. As another related technology, PTL 2 discloses a business analyzing method which is expected to proceed an adequate business analysis regardless to a category of business. Specifically, according to the business analyzing method, a superior of a analysis target person (who is a person to be target of the business analysis), evaluates the analysis target person. Also a degree of a bias of the superior is verified, and afterward the evaluation result is modified on the basis of the verification result.

PTL 3 discloses a training and personnel evaluation system for an employee. According to PTL 3, an evaluation center determines a performance evaluation score of a trainee, on the basis of an evaluation score of a training, and performance evaluation information of the trainee, which is provided by a company, that requested the training.

PTL 4 discloses a sale supporting system which is expected to execute a sales activity smoothly by optimizing a combination of a customer and a sales staff. The sale supporting system executes an individuality analysis of the customer and an individuality analysis of the sales staff, and determines the combination of the customer and the sales staff on the basis of the individuality of the customer and the individuality of the sales staff.

PTL 5 discloses a recruitment and job application supporting system using a communication network. The recruitment and job application supporting system searches for a job applicant who matches with recruiting company, and searches for a recruiting company which matches with a job applicant, based on a working condition and an analysis result of a job applicant .

PTL 6 discloses a method for providing a suitable profession diagnosing service. An technology disclosed in PTL 6 extracts a specific work style of an job openings on the basis of a result on a personality type aptitude diagnosis and a result on a job style aptitude diagnosis of a job applicant. The art disclosed in PTL 6 provides the job applicant with information about the job openings which is related to the extracted job style of the job openings.

PTL 7 discloses a recruitment and job application supporting system. The recruitment and job application supporting system encourages a job applicant to input answers to inquiries of an aptitude test via communication network. The recruitment and job application supporting system informs a recruiting company of an analysis result on the aptitude test, information of the job applicant and a working condition. Furthermore, the recruitment and job application supporting system searches for a recruiting company that matches with the analysis result and the working condition, and informs the job applicant of the recruiting company.

PTL 8 discloses an employment information providing system. The employment information providing system provides a job applicant with company information, and provides a job offering (recruiting) company with personal information. The employment information providing system encourages the job applicant to input ability information, career information and information on answers to an aptitude diagnosis, into the employment information providing system.

PTL 9 discloses a suitable profession evaluating apparatus. The suitable profession evaluating apparatus evaluates a profession category which is expected to be suitable to an examinee, based on answers written by a group that is judged to be highly suitable to the profession category as evaluation target, among answers to a group of inquiries related to evaluation.

As another related art, PTL 10 discloses a data search user interface. PTL 11 discloses an analysis apparatus which extracts opinions about a target object (for example, merchandise) automatically from a set of documents existing in the Internet or the like. The analysis apparatus is expected to compare and analyze the opinions from various points of view. PTL 12 discloses a system which is expected to realize a division of labor about a complex operation, such as a collection and delivery service through a route.

As another technology, NPL 1 discloses a technology which compresses n-gram information into an embedded vector (feature vector), when evaluating a sentence. For the embedded vector which is generated, a weight coefficient is changed on the basis of a position of n-gram in the sentence. NPL 2 discloses an technology related to Libsvm (A Library for Support Vector Machines) relating to the support vector machine.

### CITATION LIST

### Patent Literature (PTL)

[PTL 1] Japanese Patent Application Laid-Open Publication No. 2005-149034

[PTL 2] Japanese Patent Application Laid-Open Publication No. 2004-110510

[PTL 3] Japanese Patent Application Laid-Open Publication No. 2004-46770

[PTL 4] Japanese Patent Application Laid-Open Publication No. 2002-269335

[PTL 5] Japanese Patent Application Laid-Open Publication No. 2002-251451

[PTL 6] Japanese Patent Application Laid-Open Publication No. 2002-230152

[PTL 7] Japanese Patent Application Laid-Open Publication No. 2002-133169

[PTL 8] Japanese Patent Application Laid-Open Publication No. 2001-357124

[PTL 9] Japanese Patent Application Laid-Open Publication No. 2000-76329

[PTL 10] Japanese Patent Application Laid-Open Publication No. 2003-529154

[PTL 11] Japanese Patent Application Laid-Open Publication No. 2003-203136

[PTL 12] Japanese Patent Application Laid-Open Publication No. 2002-366714

### Non Patent Literature (NPL)

[NPL 1] D. Bespalov, et.al. ,“Sentiment Classification with Supervised Sequence Embedding”, Machine Learning and Knowledge Discovery in Databases, Vol. 7523, pp.159-174, Springer Berlin Heidelberg, 2012

[NPL 2] Chih-Chung Chang and Chih-Jen Lin, “LIBSVM—A Library for Support Vector Machines”, [online], [retrieved on 2014-09-08], Retrieved from the Internet:<URL:http://www.csie.ntu.edu.tw/˜cjlin/libsvm/>

### SUMMARY

An exemplary object of the invention is to provide an evaluation apparatus, an evaluation method and an evaluation system which is able to evaluate a person, who is an evaluation target, without difficulty.

An evaluation apparatus for evaluating a person, who is an evaluation target, in a first aspect of the present invention includes: a condition determining unit that is configured to determine a condition for associating a first data and an evaluation value, on the basis of the first data that includes a feature quantity of information generated according to an activity of a first evaluation target person and the evaluation value of each first evaluation target person; and an evaluation unit that is configured to calculate evaluation value of a second evaluation target person, on the basis of second data which includes a feature quantity of information generated according to an activity of the second evaluation target person, and the condition determined by the condition determining unit.

An evaluation method for evaluating a person, who is an evaluation target, in a second aspect of the present invention includes the following operations: determining a condition for associating a first data and an evaluation value, on the basis of the first data which includes a feature quantity of information generated according to an activity of a first evaluation target person, and the evaluation value of each first evaluation target person; and calculating an evaluation value of a second evaluation target person, on the basis of second data which includes a feature quantity of information generated according to an activity of the second evaluation target person, and the condition determined.

An evaluation system for evaluating a person, who is an evaluation target, in a third aspect of the present invention includes: a condition determining means for determining a condition for associating a first data and an evaluation value, on the basis of the first data that includes a feature quantity of information generated according to an activity of a first evaluation target person, and the evaluation value of each first evaluation target person; and an evaluation means for calculating an evaluation value of a second evaluation target person, on the basis of second data which includes a feature quantity of information generated according to an activity of the second evaluation target person, and the condition determined by the condition determining means.

### BRIEF DESCRIPTION OF THE DRAWINGS

Exemplary features and advantages of the present invention will become apparent from the following detailed description when taken with the accompanying drawings in which:

FIG. 1 illustrates a block diagram of an exemplary configuration of an evaluation apparatus according to a first exemplary embodiment;

FIG. 2 illustrates a flowchart that exemplifies a process which is executed by the evaluation apparatus according to the first exemplary embodiment;

FIG. 3 illustrates a block diagram of an exemplary configuration of an evaluation apparatus according to a second exemplary embodiment;

FIG. 4 illustrates an example of job applicant information which is stored in a job applicant information storing unit according to the second exemplary embodiment;

FIG. 5 illustrates another example of the job applicant information which is stored in the job applicant information storing unit according to the second exemplary embodiment;

FIG. 6 illustrates a flowchart of a process of a pre-learning step which is executed by a pre-learning unit according to the second exemplary embodiment;

FIG. 7A illustrates an example of a job applicant vector converted from resume information, in the second exemplary embodiment;

FIG. 7B illustrates an example of a job applicant vector converted from resume information of a specific job applicant, in the second exemplary embodiment;

FIG. 7C illustrates an example of a job applicant vector converted from resume information of a specific job applicant, in the second exemplary embodiment;

FIG. 7D illustrates an example of a job applicant vector converted from resume information of a specific job applicant, in the second exemplary embodiment;

FIG. 8A illustrates an example of a job applicant vector converted from a document data, in the second exemplary embodiment;

FIG. 8B illustrates an example of a job applicant vector converted from a document data of a specific job applicant, in the second exemplary embodiment;

FIG. 8C illustrates an example of a job applicant vector converted from a document data of a specific job applicant, in the second exemplary embodiment; and

FIG. 9 illustrates a flowchart of a process of a judgment step which is executed by a job applicant evaluating unit.

### EXEMPLARY EMBODIMENT

### First Exemplary Embodiment

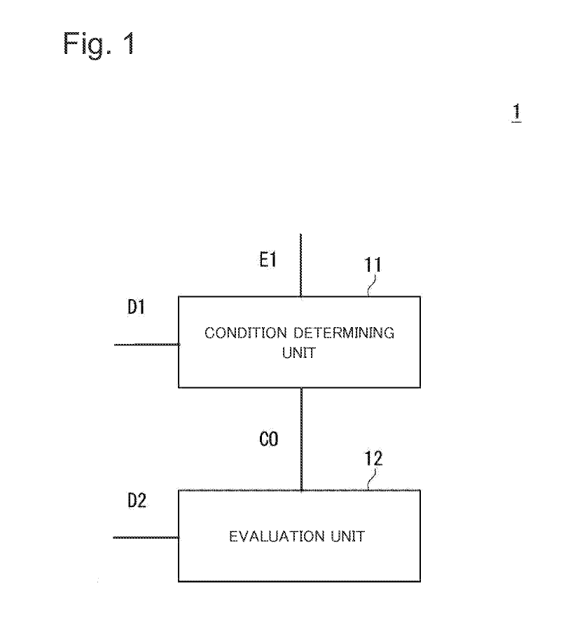

Hereinafter, a first exemplary embodiment of the present invention will be explained with reference to drawings. FIG. 1 illustrates a block diagram of an exemplary configuration of an evaluation apparatus according to a first exemplary embodiment. The evaluation apparatus 1 is an apparatus which evaluates a person who is an evaluation target. For example, the evaluation apparatus 1 may be an apparatus which is used by a corporate body such as a company or the like, and an organization such as nation, municipality (local government) or the like for employing a person. Specifically, the evaluation apparatus 1 is applied for carrying out an employment test to job applicants, or is applied for evaluating job performance in case of determining promotion or reassignment for a constituent person of an organization.

The evaluation apparatus 1 includes a condition determining unit 11 and an evaluation unit 12. Hereinafter, each unit will be explained.

The condition determining unit 11 determines a condition CO which associates a first data D1 and an evaluation value E1 based on the first data D1 and the evaluation value E1. The first data D1 includes a feature quantity of information generated according to an activity of a first target person of evaluation (hereinafter referred as “first evaluation target person”). The evaluation value E1 is set for each first evaluation target person.

Here, ‘first evaluation target person’ is a person who is an evaluation target and whose evaluation has been determined. The data D1 of ‘first evaluation target person’ is used as teacher data (training data) for determining evaluation of ‘second evaluation target person’ (mentioned later). The data D1 is, for example, document data created by the first evaluation, or data indicating activity records of the first evaluation target person. The data D1 includes a feature quantity which is useful in evaluating the first evaluation target person. The data D1 include data of plural persons as the data of the first evaluation target person.

The ‘evaluation value of each first evaluation target person’ is a value regarding to evaluation about an aptitude of each first evaluation target person.

For example, the ‘evaluation value of each first evaluation target person’ may be a value which indicates a result of employment of the first evaluation target person in an employment test, or may be a value which indicates evaluation about a job performance of each first evaluation target person.

The evaluation unit 12 finds an evaluation value E2 of a second evaluation target person, based on second data D2 and the condition CO. Specifically, the evaluation unit 12 may find the evaluation value E2, by calculation based on second data D2 and the condition CO. The second data D2 includes a feature quantity about information generated according to an activity of the second evaluation target person. The condition CO is determined by the condition determining unit 11. The ‘second evaluation target person’ is a target person whose evaluation is determined by the evaluation apparatus 1. Since the data D2 is data similar to the data D1, explanation on the data D2 is omitted.

Each component of the evaluation apparatus 1 is illustrated as a functional block that may execute various processes in the FIG. 1. Each component of the evaluation apparatus 1 may be configured by hardware including circuits such like a memory, another IC (Integrated Circuit) and the like. These components may implemented as software, that is, a program which is loaded in a memory, or the like. Accordingly, a person skilled in the art can understand that the functional block may be realized in various forms, that is, by use of only hardware, only software, or a combination of the hardware and the software. The the function block may be realized by arbitrary forms without any limitation. Is is applicable to each component according to a second exemplary embodiment.

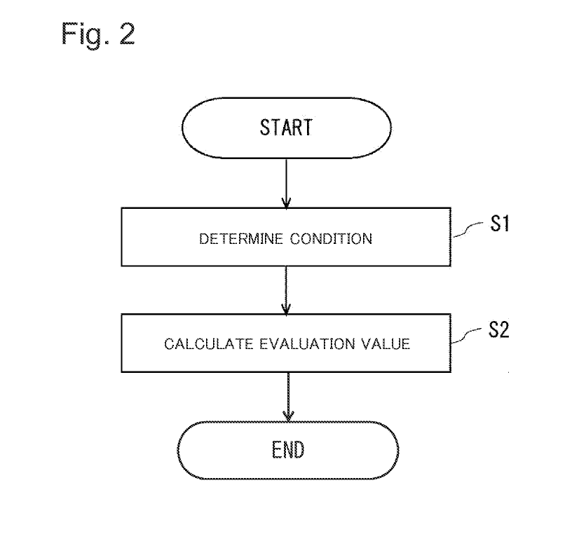

FIG. 2 illustrates a flowchart that exemplifies a process which executed by the evaluation apparatus 1. Hereinafter, the process executed by the evaluation apparatus 1 will be explained.

Firstly, the condition determining unit 11 determines the condition CO, which associates the first data D1 and the evaluation value E1, on the basis of the first data D1 and the evaluation value E1 of each first evaluation target person (Step S1).

The condition determining unit 11 determines the condition CO, which associates the first data D1 and the evaluation value E1, for each of the first evaluation target persons. In other words, by applying the condition CO to the first data D1 of each first evaluation target person, it is possible to derive the evaluation value E1 or an evaluation value close to the evaluation value E1 of each first evaluation target person. According to this way, the condition determining unit 11 executes supervised learning (a learning procedure with teacher data) in the evaluation apparatus 1.

Next, on the basis of the second data D2 and the condition CO determined in Step S1, the evaluation unit 12 finds the evaluation value of the second evaluation target person (Step S2). Specifically, the evaluation unit 12 may find the evaluation value of the second evaluation target person by calculation using the second data D2 and the condition CO determined in Step S1. By applying the condition CO to the second data D2, the evaluation unit 12 is able to derive the evaluation value E2 of the second evaluation person. The evaluation unit 12 is able to evaluate a plurality of the second evaluation target persons, in the similar way.

From the foregoing, the evaluation apparatus 1 is capable of evaluating the evaluation target person without difficulty on the basis of the data of the evaluation target person. The reason is that, the evaluation apparatus 1 executes machine learning in advance, by using data and the evaluation value of the first evaluation target person, and generates a learning parameter (for example, the condition CO). Therefore the evaluation apparatus 1 is able to find (calculate) the evaluation value of the second evaluation person without difficulty when the data of the second evaluation target person is obtained.

### Second Exemplary Embodiment

Hereinafter, a second exemplary embodiment of the present invention will be explained with reference to a drawing. The second exemplary embodiment will provide detailed explanation on a specific exemplification of the evaluation apparatus which is described in the first exemplary embodiment

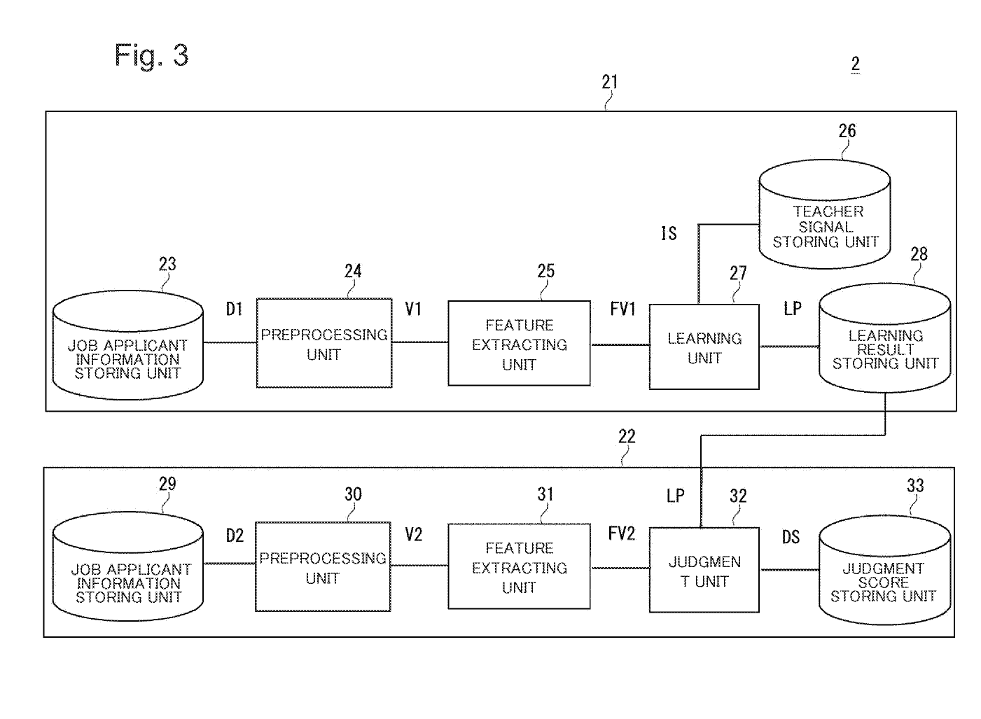

FIG. 3 illustrates a block diagram of an exemplary configuration of an evaluation apparatus according to the second exemplary embodiment. An evaluation apparatus 2 is an evaluation apparatus which is managed by a job offering company (recruiting company). The evaluation apparatus 2 evaluates a degree of excellence (or non-excellence) of a job applicant (evaluation target person) in an employment test of job applicants. The recruiting company selects the job applicant on the basis of the evaluation. For example, on the basis of the evaluation, the recruiting company judges whether selection for employment of the job applicant should be advanced to a next step or not. Or, on the basis of the evaluation, the recruiting company may judge whether the job applicant is employed or not. An organization, which conducts the employment test in place of the recruiting company, may manage the evaluation apparatus 2. The aforementioned organization may be such as a worker dispatching company or the like.

In the second exemplary embodiment, the evaluation apparatus 2 is assumed to be a server. Since a function and a hardware configuration of the server other than illustrated in FIG. 3 are known in general, explanation on those is omitted. The evaluation apparatus 2 is not limited to the server or the like, and may be another kind of computer terminal (for example, personal computer).

The evaluation apparatus 2 includes a pre-learning unit 21 and a job applicant evaluating unit 22. The pre-learning unit 21 executes supervised machine learning (a machine learning procedure using teacher data) based on data of a past job applicant. The pre-learning unit 21 generates a learning parameter which is utilized for evaluating a present job applicant. The job applicant evaluating unit 22 evaluates the present job applicant on the basis of the learning parameter which is generated by the pre-learning unit 21. The past job applicant and the present job applicant may corresponds to the first evaluation target person and the second evaluation target person in the first exemplary embodiment respectively.

The pre-learning unit 21 includes a job applicant information storing unit 23, a preprocessing unit 24, a feature extracting unit 25, a teacher signal storing unit 26, a learning unit 27 and a learning result storing unit 28. Each unit will be explained below.

The job applicant information storing unit 23 stores information about the past job applicant D1 (hereinafter, referred as “job applicant information D1”) as learning target data. The job applicant information D1 is information which is generated according to an activity of the past job applicant. The job applicant information D1 includes, for example, information about document data, or information about activity record (herein after referred as activity record information). The job applicant information D1 may correspond to the first data in the first exemplary embodiment.

The information about the document data, which is included in the job applicant information D1, may include information about an employment application sheet (especially, information about a resume or an entry sheet), information about mail(s), information about Web (World Wide Web) site (herein after referred as ‘website’), information about the activity record, or the like. Information about the resume (hereinafter referred as “resume information”) may include, for example, information, which is described in the resume, such as a name, an age, a nationality, an address (including a zip code), a commute path, an education record, a job career record, a special field, a qualification (including a license or the like), a desired employment condition or the like. Information about the entry sheet (hereinafter referred as “entry sheet information”) may include, for example, information such as a self-introduction text written by the job applicant, a reason for application, or the like. Information about mail(s) is information carried by a mail which is sent by the job applicant to the recruiting company, and includes information such as a name, a school or the like. Information about websites may include text information or the like written by the job applicant, on SNS (Social Networking Service) such as Facebook (registered trade mark) or the like, on Twitter (registered trade mark),on a bulletin board, on a blog or the like.

The activity record information may include information such as an access record on the internet, a purchase record on the internet, a movement record of the job applicant, or the like. The access record on the internet may include a log of click operations, site browsing records or the like. The access record on the internet is generated when the job applicant accesses a website (especially, such like “home page”) with a computer terminal. The activity record information is obtained, for example, when the job applicant accesses a website of the recruiting company. Also, the activity record information may be data stored in a user's mobile terminal. Specifically, the stored data may be a purchase record which indicates that the user purchases a merchandise, and the movement record of the user. The purchase record may be a record (for example, purchase record by use of electronic money) which indicates that the user purchases a merchandise by using the user's own mobile terminal. The movement record of the user may be, for example, a record of the user's movement which is detected by a GPS (Global Positioning System) sensor of the user's mobile terminal.

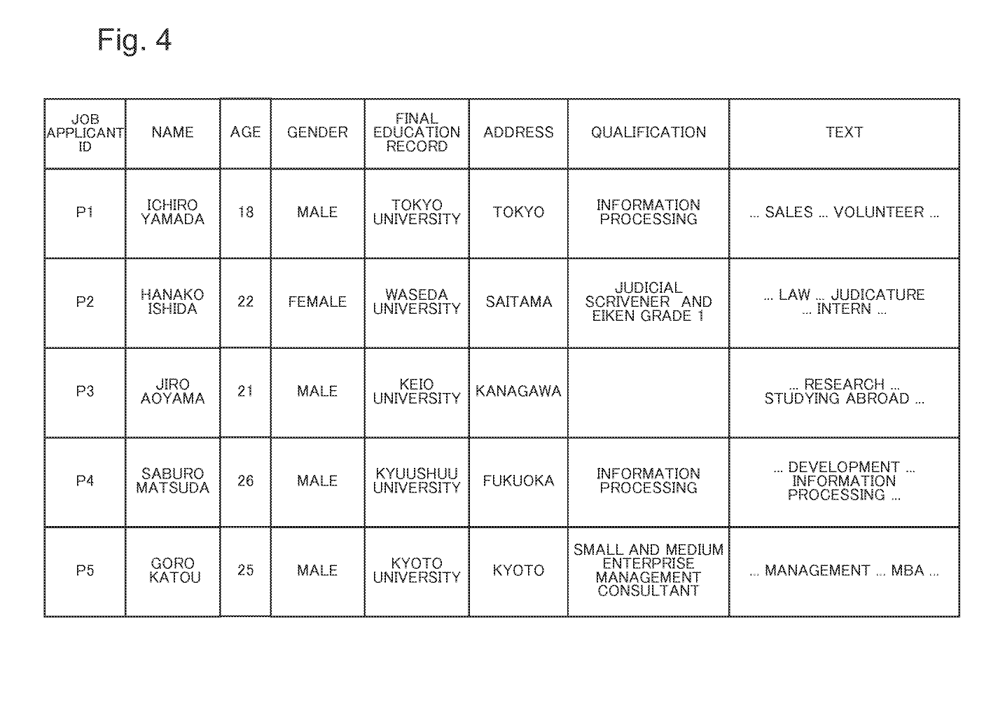

FIG. 4 illustrates an example of the job applicant information D1 which is stored in the job applicant information storing unit 23. The job applicant information D1 illustrated in FIG. 4 includes ID (Identification), a name, an age, gender, a final education record, an address, a qualification, a text and the like of the job applicant, as the resume information.

For example, the job applicant information D1, which is designated by a job applicant ID ‘P1’, includes Name ‘Ichiro YAMADA’, Age ‘18’, Gender ‘Male’, Final education record ‘Tokyo university’, Address ‘Tokyo’, Qualification ‘Information processing’ (The Information Technology Engineers Examination), Text ‘*** Sales *** Volunteer ***’. The job applicant information D1, which is designated by a job applicant ID ‘P2’, includes Name ‘Hanako ISHIDA’, Age ‘22’, Gender ‘Female’, Final education record ‘Waseda university’, Address ‘Saitama’, Qualification ‘Judicial scrivener and EIKEN (The EIKEN Test in Practical English Proficiency) GRADE one’, Text ‘*** Law *** Judicature *** Intern ***’. The job applicant information D1, which is designated by a job applicant ID ‘P3’, includes Name ‘Jiro AOYAMA’, Age ‘21’, Gender ‘Male’, Final education record ‘Keio university’, Address ‘Kanagawa’, Qualification ‘(Nothing)’, Text ‘*** Research *** Studying abroad***’. The job applicant information D1, which is designated by a job applicant ID ‘P4’, includes Name ‘Saburo MATSUDA’, Age ‘26’, Gender ‘Male’, Final education record ‘Kyuushuu university’, Address ‘Fukuoka’, Qualification ‘Information processing’, Text ‘*** Development *** Information processing ***’. The job applicant information D1, which is designated by a job applicant ID ‘P5’, includes Name ‘Goro KATOU’, Age ‘25’, Gender ‘Male’, Final education record ‘Kyoto university’, Address ‘Kyoto’, Qualification ‘Small and Medium Enterprise Management Consultant’, Text ‘*** Management *** MBA ***’.

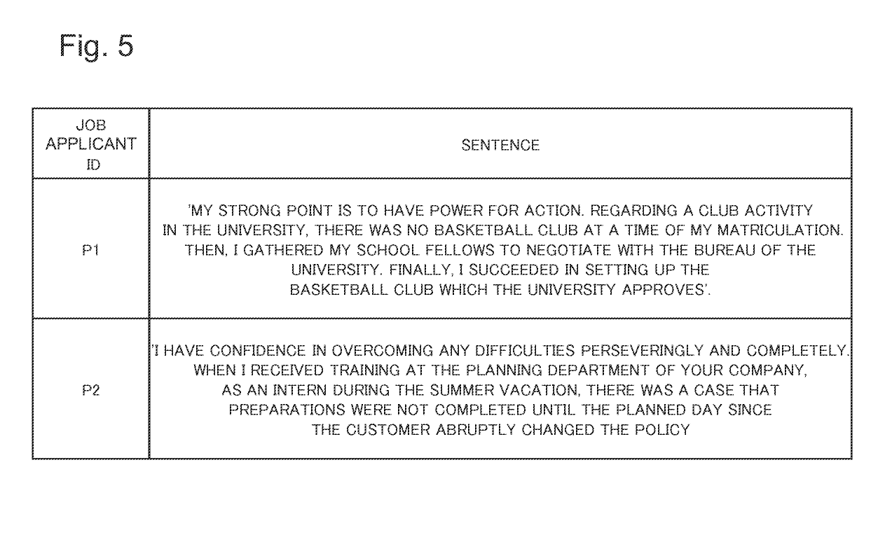

FIG. 5 illustrates another example of the job applicant information D1 which is stored in the job applicant information storing unit 23. The job applicant information D1 shown in FIG. 5 includes document data (self-introduction) described in entry sheets which are written by the job applicants of the job applicant ID ‘P1’ and ‘P2’. Information of the document data of the job applicant whose applicant ID is ‘P1’, includes text information that “My strong point is to have power for action. Regarding a club activity in the university, there was no basketball club at a time of my matriculation. Then, I gathered my school fellows to negotiate with the bureau of the university. Finally, I succeeded in setting up the basketball club which is approved by the university”. Information of the document data of the job applicant, whose job applicant ID is ‘P2’, includes text information that “I have confidence in overcoming any difficulties perseveringly and completely. When I received training at the planning department of your company, as an intern during the summer vacation, there was a case that preparations were not completed until the planned day since the customer abruptly changed the policy”.

The preprocessing unit 24 reads one record of the job applicant information D1 (job applicant information of one person) from the job applicant information storing unit 23, according to an instruction of the learning unit 27. And the preprocessing unit 24 generates one job applicant vector V1 on the basis of the one record information.

The feature extracting unit 25 extracts one or more features from the job applicant vector V1 which is generated by the preprocessing unit 24, and generates a job applicant feature vector FV1 which indicates a feature quantity of the past job applicant. When extracting the feature of the document data which is written by the job applicant, the feature extraction unit 25 may automatically select an important feature item by considering distribution of the features over the whole document, and generates the job applicant feature vector FV1. The feature extracting unit 25 may correspond to the condition determining unit 11 of the first exemplary embodiment. Or, the feature extracting unit 25 may realize, at least, a part of the configuration of the condition determining unit 11 of the first exemplary embodiment. The feature extracting unit 25 may be denoted as a first feature vector generating unit. The job applicant feature vector FV1 may corresponds to the feature quantity of the first data in the first exemplary embodiment.

The teacher signal storing unit 26 associates and stores the past job applicant and a teacher signal IS (IS is a label indicating excellence or non-excellence. The teacher signal IS may correspond to the evaluation value of the first evaluation target person in the first exemplary embodiment). For example, the teacher signal IS may be a result (success (pass) or failure) of employment judgement on the job applicant, by the recruiting company. The teacher signal IS may be a score of an employment test or an aptitude test on the job applicant. The teacher signal IS may be performance (performance indicator such like good or bad) of the job applicant after entering the recruiting company, or the like. The teacher signal storing unit 26 stores the teacher signals IS related to a plurality of the past job applicants.

The learning unit 27 reads the job applicant feature vector FV1 generated by the feature extracting unit 25. The learning unit 27 reads the teacher signal IS, which is corresponding to the job applicant feature vector (FV1) that is read above, from the teacher signal storing unit 26. The learning unit 27 executes machine learning with regard to a relation between the past job applicant and the teacher signal (label indicating excellence or non-excellence) to generate a learning parameter LP, based on the job applicant feature vector FV1 and the teacher signal IS which are read above. The learning unit 27 may correspond to the condition determining unit 11 of the first exemplary embodiment. Or, the learning unit 27 may realize, at least, a part of the configuration of the condition determining unit 11 of the first exemplary embodiment.

The learning result storing unit 28 holds (stores) the result of the learning (learning parameter LP) which is generated by the learning unit 27.

The job applicant evaluating unit 22 includes a job applicant information storing unit 29, a preprocessing unit 30, a feature extracting unit 31, a judgment unit 32 and a judgment result storing unit 33. Hereinafter, each unit will be explained.

The job applicant information storing unit 29 holds present job applicant information D2. Since the job applicant information D2 is similar to the job applicant information D1 which is stored in the job applicant information storing unit 23, explanation on the job applicant information D2 is omitted. The job applicant information D2 may correspond to the second data in the first exemplary embodiment.

According to an instruction of the judgment unit 32, the preprocessing unit 30 reads one record of the job applicant information D2 (job applicant information of one person) from the job applicant information storing unit 29. The preprocessing unit 30 generates one job applicant vector V2 on the basis of the one record information that is read above.

The feature extracting unit 31 extracts a feature from the job applicant vector V2 generated by the preprocessing unit 30, and generates a job applicant feature vector FV2 which indicates a feature quantity of the present job applicant. The feature extracting unit 31 may correspond to the the evaluation unit 12 of the first exemplary embodiment. Or, the feature extracting unit 31 may realize, at least, a part of the configuration of the evaluation unit 12 of the first exemplary embodiment. The feature extracting unit 31 may be denoted as a second feature vector generating unit. The job applicant feature vector FV2 may correspond to the feature quantity of the second data of the first exemplary embodiment.

The judgment unit 32 reads the job applicant feature vector FV2 generated by the feature extracting unit 31. And The judgment unit 32 reads the learning parameter LP which is stored in the learning result storing unit 28. The judgment unit 32 judges a degree of excellence or non-excellence of the present job applicant based on the job applicant feature vector FV2 and the learning parameter LP which are read above.

The judgment result storing unit 33 stores a judgment score DS which indicates the degree of excellence or non-excellence of the job applicant, judged by the judgment unit 32.

Next, an operation (process) of the evaluation apparatus 2 will be explained. The process executed by the evaluation apparatus 2 includes a pre-learning step and a judgment step. The pre-learning step is executed in the pre-learning unit 21, and the judgment step is executed in the job applicant evaluating unit 22.

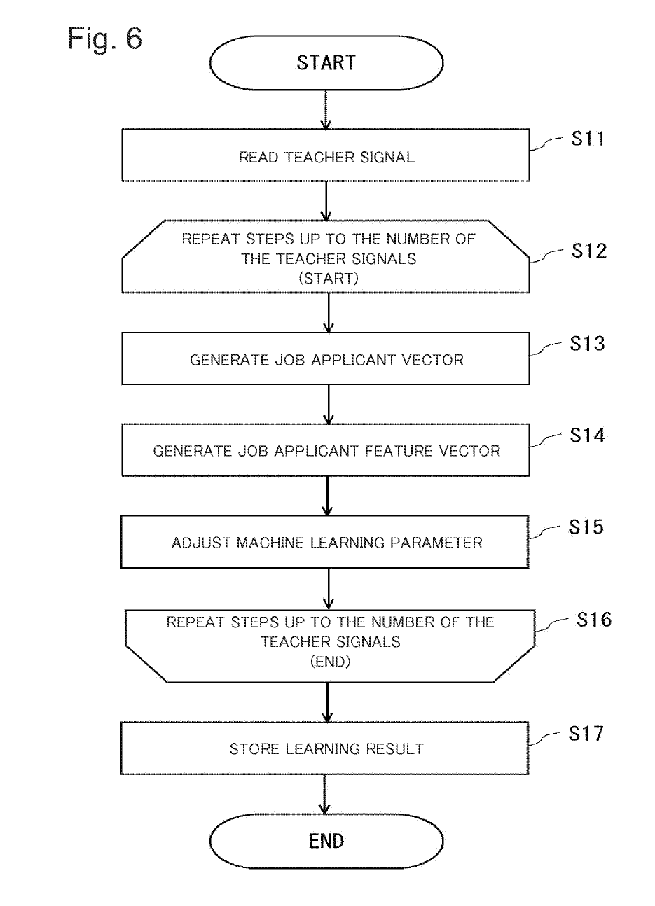

FIG. 6 is a flowchart showing a process of the pre-learning step which is carried out by the pre-learning unit 21. Hereinafter, details of the pre-learning step will be explained with reference to FIG. 6.

Firstly, the learning unit 27 reads a list of the job applicant ID and the teacher signal from the teacher signal storing unit 26 (Step S11). For example, the teacher signal IS may be expressed as a two level signal. In the case that the job applicant is judged to be excellent, the corresponding teacher signal IS is set to ‘1’. And in the case the job applicant is not excellent, the corresponding teacher signal IS is set to ‘0’.

For example, the teacher signal may be a value which indicates an result of success or failure on job application by the job applicant. That result may indicate whether the job applicant is employed by a specific company (a company which is listed in the First Section of the Tokyo Stock Exchange) or not. In this case, the teacher signal IS is set to ‘1’ when the the job applicant is employed. Also, in this case, the teacher signal IS is set to ‘0’ when the job applicant is not employed. Or, the teacher signal IS may be a value indicating the job performance of the job applicant after entering the specific recruiting company.

In this case, the teacher signal IS may be set to ‘1’ in the case that the job performance is good, and the teacher signal IS may be set to ‘0’ in the case that the job performance is bad.

The learning unit 27 reads the teacher signals IS for a plurality of the job applicants respectively. The learning unit 27 repeats processes of Step S13 to Step S15, up to the number of items (number of the job applicants) in the list which are read in Step S11 (Step S12). Procedures executed in Step S13 to Step S15 will be explained later.

Next, the learning unit 27 instructs the preprocessing unit 24 to read the job applicant information D1 which is relating to the job applicant ID acquired in Step S11. According to the instruction, the preprocessing unit 24 executes a preprocessing to the job applicant information. Specifically, the preprocessing unit 24 reads the job applicant information D1 according to the instruction of the judgment unit 32. The preprocessing unit 24 converts the job applicant information D1 (which is read above) into a form of vector to generate the job applicant vector V1 (Step S13).

The preprocessing unit 24 generates the job applicant vector V1, for example, as following. When the preprocessing unit 24 acquires the resume information illustrated in FIG. 4 from the job applicant information storing unit 23, the preprocessing unit 24 sets a code item, in the job applicant vector V1, to be 1, in case where the the gender, the address, the final education record and the license of the job applicant, that are respectively corresponding to the code item, are set in the resume information. The preprocessing unit 24 sets a code item, in the job applicant vector V1, to ‘0’, in case where the data corresponding to the code item are not set in the resume information.

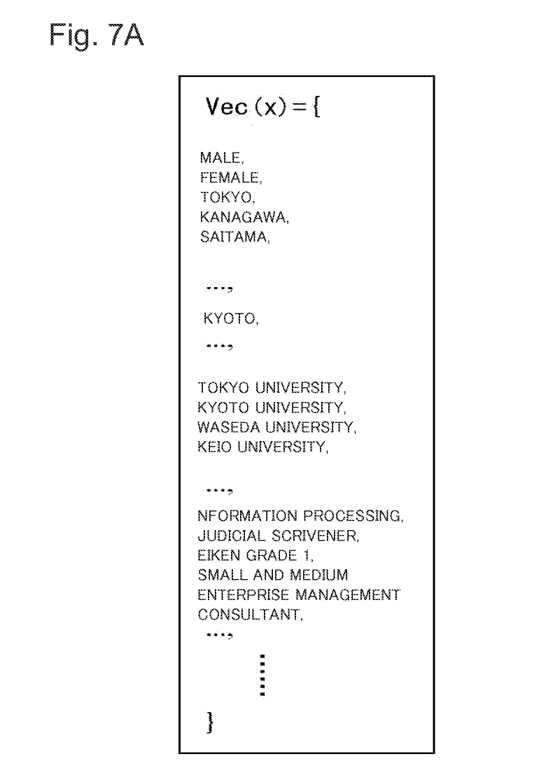

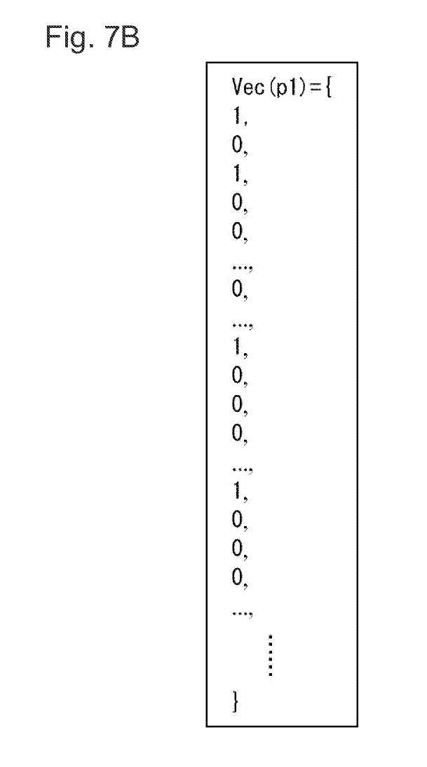

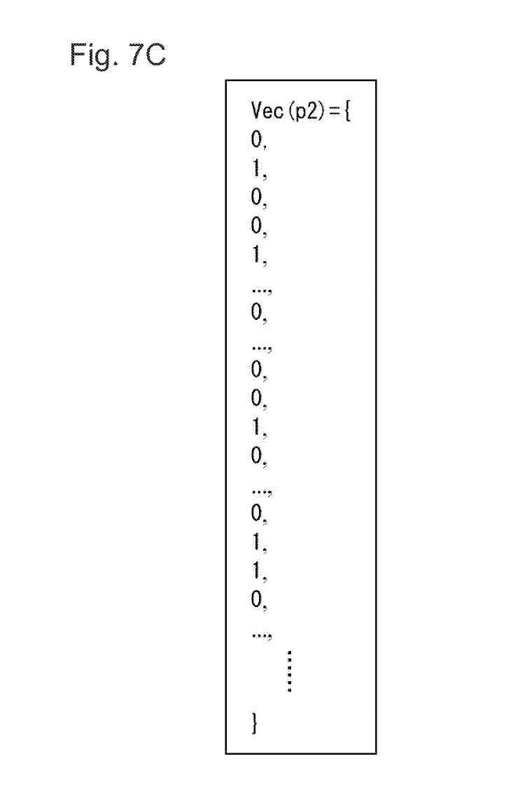

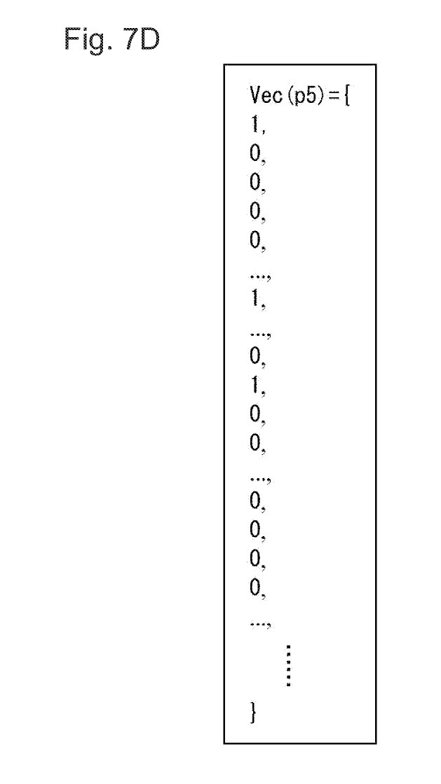

FIG. 7A shows an example of the job applicant vector into which the resume information is converted. Vec(x) represents the job applicant vector, where a variable x is the job applicant ID. In FIG. 7A, the resume information such as the gender, the address, the final education record and the qualification of the job applicant are set as the code item of the job applicant vector.

Each of FIG. 7B to FIG. 7D illustrates an example of the job applicant vector into which the resume information is converted. FIG. 7B shows an example of the job applicant vector of the job applicant who has the job applicant ID1, and FIG. 7C shows an example of the job applicant vector of the job applicant who has the job applicant ID2, and FIG. 7D shows an example of the job applicant vector of the job applicant who has the job applicant 1D5. The resume information of each job applicant is shown in FIG. 4.

In FIG. 7B, as code items in the job applicant vector for the job applicant ID1, the code items of Gender ‘Male’, Address ‘Tokyo’, Final education record ‘Tokyo university’ and Qualification ‘Information processing’ are set to ‘1’, and other code items are set to ‘0’. In FIG. 7C, as code items in the job applicant vector for the job applicant ID2, the code items of Gender ‘Female’, Address ‘Saitama’, Final education record ‘Waseda university’ and ‘Qualification ‘Judicial scrivener and EIKEN (The EIKEN Test in Practical English Proficiency) GRADE one’ are set to ‘1’, and other code items are set to ‘0’. In FIG. 7D, as code items in the job applicant vector for the job applicant ID5, the code items of Gender ‘Male’, Address ‘Kyoto’, Final education record ‘Kyoto university’ and Qualification ‘Small and Medium Enterprise Management Consultant’ are set to ‘1’, and other code items are set to ‘0’.

In the case that the preprocessing unit 24 acquires the document data illustrated in FIG. 5 from the job applicant information storing unit 23, the preprocessing unit 24 sets code items, which are corresponding to predetermined words, to be ‘1’, and sets other code items to be ‘0’. Specifically, the preprocessing unit 24 divides the document data into predetermined words, and counts number of appearances of the predetermined word in the document data. As a method of the division of the document into the word, the morphological analysis may be applied. Since the morphological analysis has been known already, detailed explanation on the morphological analysis is omitted. The preprocessing unit 24 sets the predetermined word as the item (code item) of the job applicant vector. The preprocessing unit 24 sets the the counter number of appearances of the predetermined word as a value of item in the vector. The predetermined word which is a target for counting the number of appearances may be one word or may be a phrase which includes a combination of plural words (for example, two to five words). In this case, the optimum number of the predetermined words may be changed on the basis of number of the job applicants who are a learning target, a volume of the document data, or the like. The optimum number of the words may be acquired, for example, as following. The preprocessing unit 24 selects a part of the document data as test data, and counts the number of appearance of the predetermined word in the test data, and checks accuracy of model. The preprocessing unit 24 checks the accuracy of model by changing the number of the predetermined words, and then determines the more accurate model. As a result, the preprocessing unit 24 is possible to find the optimum number of words.

The preprocessing unit 24 may limit the word which is target for counting the number of appearances. For example, the preprocessing unit 24 may exclude a word (for example, postpositional particle in Japanese) which appears very frequently in all of the documents. By executing the above-mentioned process, the preprocessing unit 24 generates a vector (expressed numerically) which includes a feature of text, that is, a feature of the job applicant who writes the text.

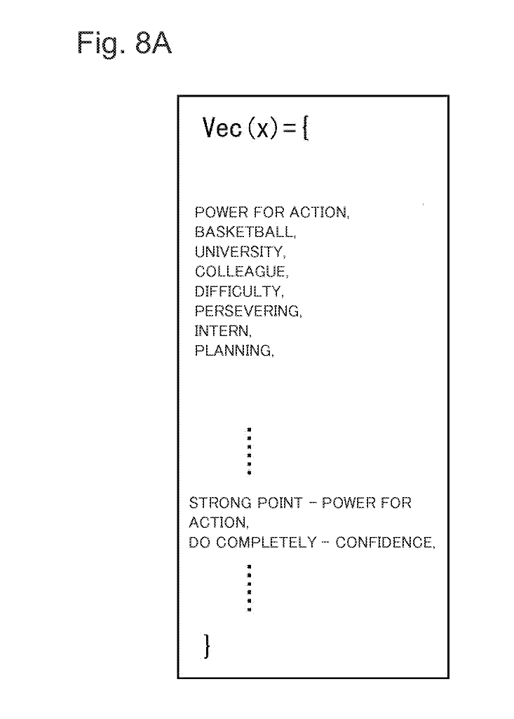

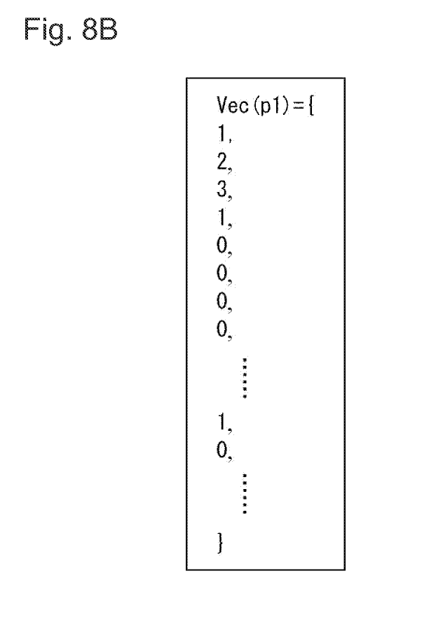

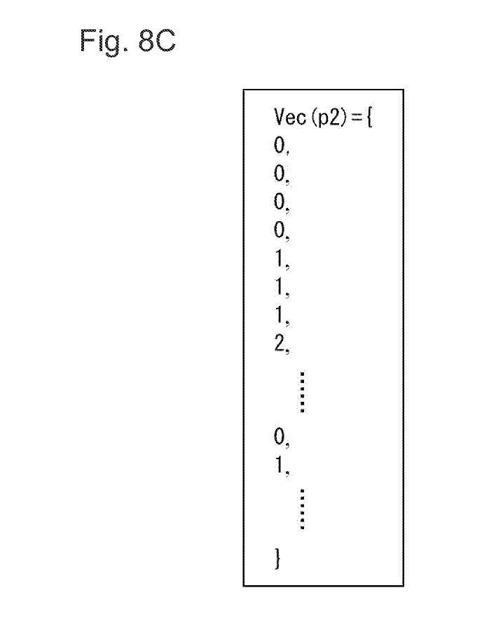

FIG. 8A illustrates an example of the job applicant vector into which the document data is converted. Vec(x) represents the job applicant vector, where the variable x represents the job applicant ID. In FIG. 8A, words such as described below are set as the code item. That is, those words such as ‘power for action’, ‘basketball’, ‘university’, ‘colleague’, ‘difficulty’, ‘persevering’, ‘intern’, ‘planning’, ***, ‘strong point—power for action’ and ‘do completely—confidence’ are set as the code item(s). Here, ‘strong point—power for action’ and ‘do completely’ are phrases each of which includes two words connected by a postpositional particle or the like which is placed between those words.

Each of FIG. 8B to FIG. 8C illustrates an example of the job applicant vector into which the document data of certain job applicant is converted. FIG. 8B illustrates an example of the job applicant vector of the job applicant who has the job applicant ID1, and FIG. 8C illustrates an example of the job applicant vector of the job applicant who has the job applicant ID2.

In FIG. 8B, as the code items of the job applicant vector regarding to the job applicant ID1, the code items such as ‘Power for action’, ‘Basketball’, ‘University’, ‘Colleague’ and ‘Strong point—power for action’ are set to ‘1’, ‘2’, ‘3’, ‘1’ and ‘1’ respectively, and other code items are set to ‘0’. In FIG. 8C, as the code items of the job applicant vector regarding to the job applicant ID2, the code items such as ‘Difficulty’, ‘Persevering’, ‘Intern’, ‘Planning’ and ‘Do completely—confidence’ are set to ‘1’ respectively, and other code items are set to ‘0’.

According to this way, the preprocessing unit 24 is able to numerically express each item of the job applicant information, and to convert all of job applicant information into a vector. Similarly, the preprocessing unit 24 is able to execute the morphological analysis to a mail which is written by the job applicant, or a document which is posted by the job applicant to SNS, or the like.

The preprocessing unit 24 also may generate the job applicant vector by converting an access record which represents access history of the job applicant to a particular website, into data which express the feature of the job applicant. Since, by using the Internet, the job applicant investigates a company or an occupation in which the job applicant is interested, it is possible to generate a vector which includes the feature (for example, an intention to a profession) of the job applicant. Similarly to the above-mentioned method for numerically expressing the text, the preprocessing unit 24 may analyze URL (Uniform Resource Locator) of an access destination, and counts access frequency, and a stay time of each access. The preprocessing unit 24 may divide a document, which is designated by URL and acquired via HTTP (Hypertext Transfer Protocol), into words, and counts number of the predetermined words which are included in the document. The preprocessing unit 24 converts the access records into a vector on the basis of the access frequency, the stay time and the number of predetermined words.

Returning to FIG. 6, explanation on the pre-learning step continues in the following. The learning unit 27 instructs the feature extracting unit 25 to read the job applicant vector V1 which is generated in Step S13. According to the instruction, the feature extracting unit 25 reads the job applicant vector V1, and extracts a feature of the job applicant vector V1. According to this way, the feature extracting unit 25 generates the job applicant feature vector FV1 (Step S14).

In general, the job applicant vector V1, which is generated in Step S13, may be vector data of which vector length is quite long. As a result, it may be difficult to use the vector V1 in a latter half of the learning step, and the judgment step as it is. Therefore, the feature extracting unit 25 generates a compressed vector (job applicant feature vector FV1) by selecting only featured item out of the job applicant vector V1.

As described above, in the case of extracting the feature of the document data written by the job applicant, the feature extracting unit 25 may select the important feature items by considering distribution of the feature over all of the document, and generates the feature vector. As a method for generating the feature vector, various methods may be applicable. For example, NPL 1 discloses a technology which is expected to generate the feature vector automatically. However, the feature extracting unit 25 may analyze the important vector element in the job applicant vector V1 by utilizing the main component analysis or the like. And the feature extracting unit 25 may generate the job applicant feature vector FV1 by selecting the important vector element. These processes can be realized, for example, by a software program which configures the feature extracting unit 25. Since the the feature extracting unit 25 generates the job applicant feature vector FV1 as mentioned above, it is possible to reduce an amount of data which is needed by the learning unit 27. As a result, it is possible to reduce a processing time of the learning unit 27.

Next, the learning unit 27 adjusts the machine learning parameter LP based on the job applicant feature vector FV1 which is calculated in Step S14, and the teacher signal IS which is acquired in Step S11 (Step S15). The machine learning is executed by using any classifier using supervised machine learning (a machine learning using teacher data). As the classifier using machine learning, for example, the support vector machine, the neural network, the Bayes (Bayesian) classifier and the like are known.

The learning unit 27 repeats the above-mentioned processes of Step S13 to Step S15, up to the number of items (number of past job applicants) in the list which are read in Step S11 (Step S16). According to this way, the learning unit 27 adjusts the learning parameter LP to be an appropriate value.

After the learning unit 27 repeats the above-mentioned processes of Step S13 to Step S15 up to the number of items in the list, the learning unit 27 stores the learning parameter LP in the learning result storing unit 28 (Step S17). According to this way, the learning parameter LP, which is used in the judgment step, is generated.

As mentioned-above, the pre-learning unit 21 executes the machine learning in the learning unit 27 on the basis of the job applicant feature vector FV1 which is generated by the feature extracting unit 25, and the teacher signal IS (including label which indicates excellence or non-excellence) of the known (past) job applicant which is stored in the teacher signal storing unit 26. According to this way, the pre-learning unit 21 adjusts the machine learning parameter (weight coefficient).

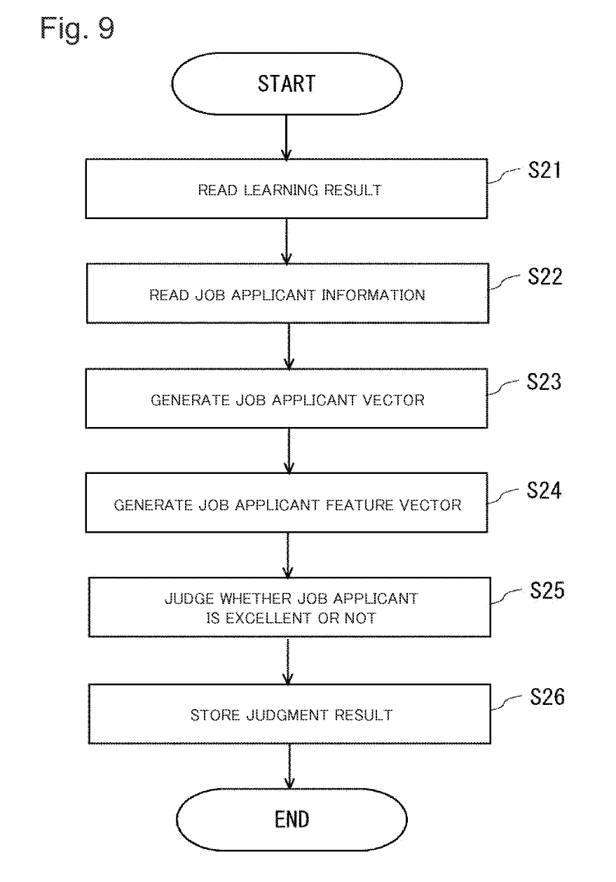

FIG. 9 exemplary illustrates a flowchart of a process of the judgment step which is executed by the job applicant evaluating unit 22. Hereinafter, details of the judgment step will be explained with reference to FIG. 9.

Firstly, the judgment unit 32 reads the learning parameter LP from the learning result storing unit 28 (Step S21). Next, the judgment unit 32 instructs the preprocessing unit 30 to read the job applicant information D2 which is a target for calculating a score for judgment on excellence or non-excellence (Step S22).

According to the instruction of the judgment unit 32, the preprocessing unit 30 reads the job applicant information D2, and executes a preprocessing. According to this, the judgment unit 30 generates the job applicant vector V2 into which the job applicant information D2 is converted as the vector form (Step S23). The process in the present step (Step S23) is similar to the process in Step S13.

The judgment unit 32 instructs the feature extracting unit 31 to read the job applicant vector V2 which is generated in Step S23. According to the instruction, the feature extracting unit 31 reads the job applicant vector V2, and extracts the feature of the job applicant vector V2 to generate the job applicant feature vector FV2 (Step S24). The process in the present step is similar to the process in Step S14. As mentioned above, since the feature extracting unit 31 generates the job applicant feature vector FV2, it is possible to reduce an amount of data which is needed by the judgment unit 27. As a result, it is possible to reduce a process time of the judgment unit 32.

The judgment unit 32 calculates the judgment score DS (judgment result), which is used to judge (determine) whether the job applicant to be a target is excellent or not. The judgment score DS is calculated on the basis of the job applicant feature vector FV2 which is generated in Step S24, and the learning parameter LP (Step S25). For an example, the judgment score which indicates excellence or non-excellence may be a numerical value which is called probability (degree of confidence or degree of reliability) of the support vector machine. In the case of calculating the judgment score by use of the support vector machine, the judgment unit 32 may use, for example, the Libsvm (described in NPL 2) with ‘-b’ option, as a probability estimating function.

The judgment unit 32 associates the judgment score DS of the job applicant, which is calculated in Step S25, with the job applicant ID of the job applicant, and stores in the judgment result storing unit 33 (Step S26). In the case that the learning, in the above described pre-learning steps, is executed by use of the teacher signal IS which has a label ‘1’ for the excellent job applicant, and has a label ‘0’ for the non-excellent job applicant, the judgment score DS which is calculated by the judgment unit 32 has a value between 0 and 1. The judgment score DS has a value close to ‘1’ as a probability, that a person who is a judgment target is excellent, becomes high. On the other hand, the judgment score DS has a value close to ‘0’ as a probability, that a person who is a judgment target is not excellent, becomes high.

As mentioned above, by reading the learning result of the pre-learning step, the judgment unit 32 sets the machine learning parameter (weight coefficient). And the judgment unit 32 judges whether the job applicant is excellent or not on the basis of the job applicant feature vector FV2 of the present job applicant which is generated by the feature extracting unit 31, and the machine learning parameter. The judgment unit 32 stores the judgment score DS in the judgment result storing unit 33.

According to this way, the evaluation apparatus 2 is able to evaluate the present job applicant without difficulty. For example, in the case that the method described in PTL 1 is used for evaluating the job applicant, it is required to execute the aptitude test for the job applicant who is an analysis target. Since the aptitude test needs many costs and times, it is difficult to lead many job applicants to take the aptitude test. A personnel (human resource) person of the recruiting company may be possible to estimate characteristic of the job applicant on the basis of the resume information which is written by the job applicant. However, it takes many efforts and times for the personnel person to read the resumes per a sheet and to evaluate the job applicants. In contrast, the evaluation apparatus 2 according to the second exemplary embodiment generates the learning parameter in advance on the basis of the resume information data of the known (past) job applicant or the like. Consequently, it is possible to evaluate the present job applicant without difficulty if the resume information data of the present job applicant or the like exists. Therefore, according to the evaluation apparatus 2, it is possible to narrow down and to select the suitable job applicants without difficulty, out of many job applicants. As a result, it is possible to reduce the time and effort which are required for the personnel person to understand and to compare the job applicant information such as the resume, the self-introduction or the like.

For example, assuming the case that the above mentioned calculation of the judgment score is executed to a plurality of the job applicants. By rearranging the plural job applicants in an order of high judgment score, the recruiting company may extract some job applicants (job applicants who are estimated to be excellent) whose judgment scores DS are ranked at a upper position. The recruiting company may take action such as leading the extracted job applicant to advance to a next selection step for employment. Or, the recruiting company also is able to extract some job applicants (job applicants who are estimated to be not excellent) whose judgment scores DS are ranked at a lower position. The recruiting company may take action such as judging that the extracted job applicant is not employed. According to this way, the judgment score DS, which the judgment unit 32 calculates, can be used for filtering the job applicant.

In the case that the teacher signal IS is a value which indicates an result of employment test (success or failure) of the past job applicant, the judgment unit 32 judges an estimated result of employment test of the present job applicant. For example, it is assumed that the teacher signal IS is set to ‘1’ in the case that the result of employment test indicates “success”, and is set to ‘0’ in the case that the employment test result indicates “failure”. And also, it is assumed that the job applicant feature vectors FV1 and FV2 are data from which feature data that causes the difference in judgments on employment are extracted, out of information included in job application sheet of the job applicants or the like. In this case, as the judgment score DS, which is calculated for the present job applicant by the judgment unit 32, is close to ‘1’, it is estimated that the employment test result of the job applicant is close to ‘success’ (the probability to be employed is high). On the other hand, as the judgment score DS, which is calculated for the present job applicant, is close to ‘0’, it is estimated that the employment test result of the job applicant is close to ‘failure’ (probability to be employed is low). In other words, as the judgment score DS, which is calculated for the present job applicant, is close to ‘1’, it may be estimated that the job applicant is excellent. Therefore, in the case that the calculated judgment score DS has a value close to ‘1’ (for example, in the case that the judgment score DS is equal to or larger than 0.8), the recruiting company may take action such as leading the job applicant to advance to a next selection step. Accordingly, it is possible to evaluate the excellent person without difficulty at the employment test.

The teacher signal IS may be a value which indicates a job performance (excellence or non-excellence) which the past job applicant achieves after being employed. In this case, the judgment unit 32 judges a job performance which is estimated to be achieved by the present job applicant after the recuruiting company employs the present job applicant. For example, it is assumed that the teacher signal IS is set to ‘1’ in the case that the job performance is excellent, and is set to ‘0’ in the case that the job performance is not excellent. And also it is assumed that the job applicant feature vectors FV1 and FV2 are data from which feature data, that causes the difference of excellent or not in the job performance, are extracted out of information included in the job application sheet or the like of the job applicants. In this case, as the judgment score DS, which is calculated for the present job applicant, is close to ‘1’, it is estimated that the job performance, which is estimated to be achieved by the present job applicant after the recruiting company employs the present job applicant, is ‘excellent’. On the other hand, as the judgment score DS, which is calculated for the present job applicant, is close to ‘0’, it is estimated that the job performance, which is estimated to be achieved by the present job applicant after the recruiting company employs the present job applicant, is ‘not excellent’. Accordingly, in the case that the calculated judgment score DS has a value close to ‘1’, the recruiting company may take action such as leading the job applicant to advance to a next selection step.

The teacher signal IS may be a value which indicates the job performance (excellence or non-excellence) per the occupational type (job type) which the past job applicant achieves after being employed. The occupational type may be, for example, a sales job, an office work, technology development or the like In this case, as shown in the following, the judgment unit 32 judges the job performance which is estimated to be achieved per the occupational type by the present job applicant, after the recruiting company employs the present job applicant.

The feature extracting unit 25 generates the job applicant feature vector of the past job applicant. The teacher signal storing unit 26 stores the teacher signal IS per the occupational type. The learning unit 27 adjusts the learning parameter per the occupational type on the basis of the job applicant feature vector, and the teacher signal IS per the occupational type, and stores the adjusted learning parameter in the learning result storing unit 28. That is, the learning unit 27 generates plural types of learning parameter. The feature extracting unit 31 generates the job applicant feature vector of the present job applicant. The judgment unit 32 calculates the judgment score DS per the occupational type on the basis of the job applicant feature vector, and the learning parameter per the occupational type which the job applicant desires.

The job applicant information storing unit 23 to the feature extracting unit 25 may generate the job applicant feature vector of the past job applicant per the occupational type. The teacher signal storing unit 26 stores the teacher signal IS per the occupational type. The learning unit 27 adjusts the learning parameter per the occupational type on the basis of the job applicant feature vector and the teacher signal IS, and stores the adjusted learning parameter in the learning result storing unit 28. Similarly, the job applicant information storing unit 29 to the feature extracting unit 31 generate the job applicant feature vector of the present job applicant per the occupational type which the job applicant desires. The judgment unit 32 calculates the judgment score DS per the occupational type on the basis of the job applicant feature vector and the learning parameter.

Based on the above, the judgment unit 32 judges the job performance per the occupational type which is estimated to be achieved by the present job applicant after the recruiting company employs the present job applicant. According to this way, the recruiting company can select the job applicant with regard to the occupational type that the judgment score DS of the job applicant is high, based on the the judgment score DS of the job applicant. For example, in the case that the job applicant states a desired occupational type in the employment beforehand, the judgment unit 32 may refer to the data. Then, the judgment unit 32 may advance the selection of the job applicant regarding the occupational type, which the job applicant desires and which the judgment score DS of the job applicant is equal to or is larger than a predetermined value. According to this way, the recruiting company can execute the selection which reflects the aptitude of the job applicant.

### Third Exemplary Embodiment

According to the second exemplary embodiment, the comprehensive judgment whether the job applicant is excellent or not is executed on the basis of one point of view. In contrast, according to a third exemplary embodiment, judgment on the job applicant is executed with regard to each of various characteristics (skill, personality or the like), and an aptitude of the job applicant is judged comprehensively on the basis of the judgment results. For example, according to the third exemplary embodiment, a judgment score is calculated per the characteristic of personality. The personality, for example, may be such as extroversion or introversion, activeness or thoughtfulness, impulsiveness or deliberateness, perseverance or flexibility, offensiveness or defensiveness, and pessimism or optimism. According to the above, it is possible to estimate the each characteristic of the present job applicant. On the basis of the estimation result, it is possible to extract the job applicant who has a predetermined characteristic. Since a configuration and a process of the evaluation apparatus according to the third exemplary embodiment are similar to ones according to the second exemplary embodiment, detailed explanation on ones are omitted.

For example, assuming a case of extracting the job applicant, who is extrovert, active, impulsive, flexible, defensive and optimistic, with regard to the above-mentioned 6 items related to the personality, and especially who thinks that the activeness and flexibility are important. In this case, a teacher signal IS1, such as below, is set in the teacher signal storing unit 26. That is, the teacher signal IS1 has a value ‘1’ (the value of the IS1 is set to ‘1’) in the case of the extrovert job applicant, and has a value ‘0’ (the value of the IS1 is set to ‘0’) in the case of the introvert job applicant. Similarly, a teacher signal IS2, which has a value ‘1’ in the case of the active job applicant, and has a value ‘0’ in the case of the thoughtful job applicant, is set in the teacher signal storing unit 26. A teacher signal IS3, which has a value ‘1’ in the case of the impulsive job applicant, and has a value ‘0’ in the case of the deliberate job applicant, is set. A teacher signal IS4, which has a value ‘1’ in the case of the persevering job applicant, and has a value ‘0’ in the case of the flexible job applicant, is set. A teacher signal IS5, which has a value ‘1’ in the case of the offensive job applicant, and has a value ‘0’ in the case of the defensive job applicant, is set. A teacher signal IS6, which has a value ‘1’ in the case of the pessimistic job applicant, and has a value ‘0’ in the case of the optimistic job applicant, is set. As mentioned above, the teacher signal related to each item is stored in the teacher signal storing unit 26.

Then, by executing the above-mentioned machine learning by using the teacher signal IS1, the learning unit 27 generates a learning parameter LP1 which is used for judging whether the job applicant is extrovert or introvert. The learning unit 27 also executes the machine learning with regard to the other teacher signals IS2 to IS6, to generate learning parameters LP2 to LP6 respectively. That is, the learning unit 27 generates the 6 learning parameters LP1 to LP6 and outputs the learning parameters LP1 to LP6 to the learning result storing unit 28.

The judgment unit 32 calculates a judgment score which is used for judging whether the present job applicant is extrovert or introvert, by applying the learning parameter LP1 to the job applicant feature vector FV2 which is generated by the feature extracting unit 31. For example, when denoting the judgment score as v1, it is possible to estimate that, as v1 is close to ‘1’, the job applicant is extrovert, and, as v1 is close to ‘0’, the job applicant is introvert. Similarly, the judgment unit 32 calculates judgment scores of other 5 items. For example, a judgment score, which judges whether the present job applicant is active or thoughtful, is denoted as v2. A judgment score, which judges whether the present job applicant is impulsive or deliberate, is denoted as v3. A judgment score, which judges whether the present job applicant is persevering or flexible, is denoted as v4. A judgment score, which judges whether the present job applicant is offensive or defensive, is denoted as v5. A judgment score, which judges whether the present job applicant is pessimistic or optimistic, is denoted as v6. It is possible to estimate that, as v2 is close to ‘1’, the job applicant is active, and, as v2 is close to ‘0’, the job applicant is thoughtful. It is possible to estimate that, as v3 is close to ‘1’, the job applicant is impulsive, and, as v3 is close to ‘0’, the job applicant is deliberate. It is possible to estimate that, as v4 is close to ‘1’, the job applicant is persevering, and, as v4 is close to ‘0’, the job applicant is flexible. It is possible to estimate that, as v5 is close to ‘1’, the job applicant is offensive, and, as v5 is close to ‘0’, the job applicant is defensive. It is possible to estimate that, as v6 is close to ‘1’, the job applicant is pessimistic, and, as v6 is close to ‘0’, the job applicant is optimistic.

The judgment unit 32 may calculate a total judgment score V of the present job applicant by using the following equation 1.

V=v1*1.0+v2*2.0+v3*1.0+(1−v4)*2.0+(1−v5)*1.0+(1−v6)*1.0 (1)

By the above-mentioned characteristics of v1 to v6, as the present job applicant has a personality which is close to the extrovert, active, impulsive, flexible, defensive and pessimistic personality, the judgment score V, which is calculated by use of the equation (1), becomes high. Accordingly, by extracting (selecting) the job applicant who has the judgment score V equal to or larger than a predetermined threshold value, it is possible to extract (select) the job applicant who has the extrovert, active, impulsive, flexible, defensive and pessimistic personality. Especially, according to the equation (1), since a weight coefficient for each of the judgment scores v2 and (1—v4) is larger than weight coefficients of other judgment scores, the characteristic, that the job applicant is active and flexible, more significantly affects to the judgment score V than the other characteristics. Therefore, it is possible to extract the job applicant who thinks that the activeness and the flexibility are important especially.

As mentioned above, the evaluation apparatus according to the third exemplary embodiment calculates the judgment score of the job applicant for each of the various characteristics (skill, personality and the like). And consequently, the evaluation apparatus according to the third exemplary embodiment is able to judge the aptitude of the job applicant on the basis of these judgment scores. Therefore, the evaluation apparatus according to the third exemplary embodiment is able to judge the aptitude of the job applicant from many points of view. Especially, when adding a plurality of the judgment scores, by changing each weight coefficient of the judgment score, it is possible to obtain the judgment result on the job applicant which highly evaluates the characteristic considered to be important.

The characteristic, of which score is highly evaluated, can be changed adequately according to the occupational type which needs the job applicant. An addition equation for evaluating the job applicant is not limited to the equation (1). For example, the addition equation for evaluating the job applicant may be not the first order addition equation but a second order or a higher order addition equation. Also, the personality is not limited to the above-mentioned example. In the case that there are a first personality and a second personality which have nature contradictory to each other, the teacher signal is set to ‘1’ with regard to the first personality, and is set to ‘0’ with regard to the second personality. Number of the characteristics is not limited to 6 of the above-mentioned example, and may be another number (number of 2 or more) such as 2, 3, . . . , or the like.

The evaluation apparatus according to each exemplary embodiment which can implement one aspect of the present invention is applicable to human resource management in general. For example, the present invention is applicable to an operation of human resource management, such as employment of a new employee, a midway employee or a part time employee, an in-house personnel affair (change or promotion), re-employment mediation, manpower dispatching, or the like.

Here, the present invention is not limited to the above-mentioned exemplary embodiments, and can be modified appropriately without departing from the spirit and scope of the present invention. For example, in the second exemplary embodiment, if an amount of information of the job applicant vector V1 is not large, the job applicant vector V1 may be used as the job applicant feature vector FV1 as it is. This is similar to the job applicant vector V2.

The condition for associating the data on the first evaluation target person and the evaluation value of the first evaluation target person in the first exemplary embodiment may be, for example, the learning parameter in the second and the third exemplary embodiments. The learning parameter is acquired, for example, by executing machine learning with regard to the relation between the data (job applicant information) on the first evaluation target person (for example, past job applicant), and the evaluation value of each first evaluation target person, in the second and the third exemplary embodiments.

In the second and the third exemplary embodiments, it is judged that, as the calculated judgment score is high, the job applicant is excellent (has an preferable aptitude). In contrast, the judgment score may be calculated so that, as the calculated judgment score is low, the job applicant may be judged to be excellent (has an preferable aptitude).

In the flowchart shown in FIG. 2, Step S3 may be executed before Step S2. Moreover, in the flowchart shown in FIG. 6, Step S11 may be executed between Step S13 and Step S15. Similarly, in the flowchart shown in FIG. 9, Step S21 may be executed between Step S22 and Step S25.

While the teacher signal is expressed as the binary classification value (such as ‘1’ and ‘0’) in the second and the third exemplary embodiments, the teacher signal may be expressed as multi-level classification value (for example, integer between 0 and 100) or a continuous value (for example, continuous value between 0 and 1). For example, data such as a score of a certain check item of the aptitude test, an average value or an accumulated value of the job performance after employment, or the like may be used as the teacher signal. Furthermore, number of the pressing the ‘Like’ button on Facebook by the job applicant with respect to the recruiting company, number of tweets on Twitter, number of writing on the Internet bulletin board, or the like may be used as the teacher signal.

Each of the job applicant information D1 and the job applicant information D2 may be data which include the document data written by the job applicant. The feature extracting unit 25 generates the feature vector FV1 with regard to a predetermined word included in the document data (first document data) written by the past job applicant. The feature extracting unit 31 generates the feature vector FV2 which with regard to a predetermined word included in the document data (second document data) written by the present job applicant. According to this way, the evaluation apparatus 2 can use the predetermined word, which indicates whether the job applicant is excellent or not, in the document data expressing the characteristic of the job applicant, as a reference for evaluation. Accordingly, it is possible to evaluate accurately whether the present job applicant is excellent or not. Especially the document data may be the resume data. By using the resume data, it is possible to evaluate accurately whether the present job applicant is excellent or not by use of the job application sheet which is used commonly in the employment test.

Each of the job applicant information D1 and the job applicant information D2 may be data which include the activity record of the job applicant. In the case of using the data which includes the activity record of the job applicant, the evaluation apparatus 2 is able to reflect the characteristic of the job applicant, which is difficult to be confirmed only from document written by the job applicant, in the evaluation of the job applicant. As a result, it is possible to evaluate multilaterally from several points of view whether the present job applicant is excellent or not. For example, the activity record may include a record on the Internet access. On the basis of the record (first activity record) on the Internet access of the past job applicant, the feature extracting unit 25 generates the feature vector FV1 with regard to the word included in the document on the website which is accessed by the past job applicant. Similarly, on the basis of the record (second activity record) on the Internet access of the present job applicant, the feature extracting unit 31 generates the feature vector FV2 with regard to the word included the document on the website which is accessed by the present job applicant. According to this way, by reflecting intention of the job applicant which is observed in the Internet browsing, the evaluation apparatus 2 can evaluate whether the present job applicant is excellent or not.

In the first to the third exemplary embodiments, an exemplary configuration, that each processing unit, which executes the process, is included in the single evaluation apparatus, has been explained. However, processing units, which executes processes similar to the processes executed by the above-mentioned processing units, may be arranged separately in a plurality of apparatus. The plurality of apparatus may configure one evaluation system. Processes carried out by that evaluation system are similar to the processes carried out by the above-mentioned evaluation apparatus.

The processes executed by the above-mentioned evaluation apparatus may be executed by a computer, as one of control (operation) methods. For example, the flow of processes, which are shown in the first exemplary embodiment, may be executed by the computer, as a control program. Similarly, it is possible to operate the computer to execute other process flows.

It is possible to store the program in various types of the non-transitory computer readable medium, and to provide the computer with the program. The non-transitory computer readable medium includes various types of the tangible storage medium. An example of the tangible storage medium includes a magnetic record medium (for example, a flexible disk, a magnetic tape, a hard disk drive), an optical magnetic record medium (for example, an optical magnetic disk), CD-ROM, CD-R, CD-R/W, a semiconductor memory (for example, a mask ROM, PROM (Programmable ROM), EPROM (Erasable PROM), a flash ROM, RAM (Random Access Memory)). The program may be provided to the computer by the various types of the transitory computer readable medium. An example of the transitory computer readable medium includes an electric signal, an optical signal and an electromagnetic wave. The transitory computer readable medium can provide the computer with the program through a wired communication path such as an electric wire, an optical fiber or the like, or a wireless communication path.

Here, there is the following situation with regard to the present invention which has been explained by the above-mentioned exemplary embodiments.

That is, recently, a job offering (recruiting) information site on the Internet is used widely in the job application (such as job-hunting or job-searching) activity. In general, in order to execute the job application activity by using job offering information site, firstly, the job applicant registers the his or her own resume information (name, age, education record, job career, license, qualification, desired employment condition or the like) with the job offering information site. Next, the job applicant selects a company, which matches with an preferable condition, out of the job offering (recruiting) companies which are registered in the site, and executes an entry (application) for employment.

On the other hand, the recruiting company firstly registers the job offering information (company information, employment occupational type, employment condition or the like) with the job offering information site, and selects a job applicant, who matches with desirable human resources for the company, among the job applicants each of whom applied for employment of the company. For example, the recruiting company extracts (selects) a job applicant, who will be an examinee of the employment test, among the job applicants. And the recruiting company carries out the employment test such as a written examination, an oral examination or the like to the selected job applicant. Then, the company judges whether the job applicant is employed or not. The employment test may be carried out not by the recruiting company but by a mediation company such as a manpower dispatching company or the like.

On this occasion, since it is required for the job recruiting company to select the job applicant, who will be the examinee of the employment test among many job applicants, it takes many efforts and times for selecting the job applicant. Therefore, there is a tendency that the recruiting company selects the job applicant by referring only simple condition such as the education record of the job applicant or the like, in order to reduce the effort and time for selection. In this case, even if a job applicant is excellent, the job applicant, who does not match with the simplified condition, is not selected as the examinee of the employment test (as the result, such job applicant is not employed). As a result, the recruiting company misses a chance to employ the excellent job applicant.

As mentioned above, the above-mentioned PTL 1 is related to the technology to present (suggest) the condition for leading the constituent member to success on the basis of the evaluation of the constituent member. Moreover, PTL1 does not disclose a technology to derive an evaluation of an unknown job applicant. Similarly, PTLs 2 to 12 do not disclose solution of the problem.

In contrast, according to the present invention, it is possible to provide the evaluation apparatus, the evaluation method and the evaluation system which is able to evaluate the person (job applicant), who is the evaluation target, without difficulty on the basis of the data on the person who is the evaluation target, for example.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. An evaluation apparatus for evaluating an evaluation target person, comprising:
a condition determining unit that is configured to determine a condition for associating a first data and an evaluation value, on the basis of the first data that includes a feature quantity of information generated according to an activity of a first evaluation target person and the evaluation value of each first evaluation target person; and
an evaluation unit that is configured to calculate evaluation value of a second evaluation target person, on the basis of second data which includes a feature quantity of information generated according to an activity of the second evaluation target person, and the condition determined by the condition determining unit.

2. The evaluation apparatus according to claim 1, wherein
the evaluation apparatus is an apparatus which is able to execute selection of the second evaluation target person when employing a person,
the evaluation value of each first evaluation target person is a value which indicates a judgment result on employment of each first evaluation target person, and
the evaluation value of the second evaluation target person is an estimated judgment result on employment of the second evaluation target person.

3. The evaluation apparatus according to claim 1, wherein
the evaluation value of each first evaluation target person is a value which indicates a job performance of each first evaluation target person, and
the evaluation value of the second evaluation target person is an estimated job performance of the second evaluation target person.

4. The evaluation apparatus according to claim 1, wherein
the evaluation value of each first evaluation target person is a value which indicates a job performance of each first evaluation target person per an occupational type, and
the evaluation value of the second evaluation target person is an estimated job performance of the second evaluation target person per the occupational type.

5. The evaluation apparatus according to claim 1, further comprising:
a first feature vector generating unit and a second feature vector generating unit, wherein
the first feature vector generating unit generates a feature vector of the information, which is generated according to the activity of the first evaluation target person, as the first data, and
the second feature vector generating unit generates a feature vector of the information, which is generated according to the activity of the second evaluation target person, as the second data.

6. The evaluation apparatus according to claim 5, wherein
the information, which is generated according to the activity of the first evaluation target person, includes first document data which is written by the first evaluation target person,
the information, which is generated according to the activity of the second evaluation target person, includes second document data which is written by the second evaluation target person,
the first feature vector generating unit generates a feature vector with regard to a predetermined word included in the first document data, as the first data, and
the second feature vector generating unit generates a feature vector with regard to a predetermined word included in the second document data, as the second data.

7. The evaluation apparatus according to claim 5, wherein
the information, which is generated according to the activity of the first evaluation target person, is data including, at least, a first activity record of the first evaluation target person, and
the information, which is generated according to the activity of the second evaluation target person, is data including, at least, a second activity record of the second evaluation target person.

8. The evaluation apparatus according to claim 7, wherein
the first activity record includes a record of an Internet access which is executed by the first evaluation target person,
the second activity record includes a record of an Internet access which is executed by the second evaluation target person,
the first feature vector generating unit generates a feature vector, which is related to a word included a document on a website accessed by the first evaluation target person, as the first data on the basis of the record of the Internet access which is executed by the first evaluation person, and
the second feature vector generating unit generates a feature vector, which is related to a word included a document on a website accessed by the second evaluation target person, as the second data on the basis of the record of the Internet access which is executed by the second evaluation person.

9. The evaluation apparatus according to claim 2, further comprising:
a first feature vector generating unit and a second feature vector generating unit, wherein
the first feature vector generating unit generates a feature vector of the information, which is generated according to the activity of the first evaluation target person, as the first data, and
the second feature vector generating unit generates a feature vector of the information, which is generated according to the activity of the second evaluation target person, as the second data.

10. The evaluation apparatus according to claim 3, further comprising:
a first feature vector generating unit and a second feature vector generating unit, wherein
the first feature vector generating unit generates a feature vector of the information, which is generated according to the activity of the first evaluation target person, as the first data, and
the second feature vector generating unit generates a feature vector of the information, which is generated according to the activity of the second evaluation target person, as the second data.

11. The evaluation apparatus according to claim 4, further comprising:
a first feature vector generating unit and a second feature vector generating unit, wherein
the first feature vector generating unit generates a feature vector of the information, which is generated according to the activity of the first evaluation target person, as the first data, and
the second feature vector generating unit generates a feature vector of the information, which is generated according to the activity of the second evaluation target person, as the second data.

12. The evaluation apparatus according to claim 9, wherein
the information, which is generated according to the activity of the first evaluation target person, includes first document data which is written by the first evaluation target person,
the information, which is generated according to the activity of the second evaluation target person, includes second document data which is written by the second evaluation target person,
the first feature vector generating unit generates a feature vector with regard to a predetermined word included in the first document data, as the first data, and
the second feature vector generating unit generates a feature vector with regard to a predetermined word included in the second document data, as the second data.

13. The evaluation apparatus according to claim 10, wherein
the information, which is generated according to the activity of the first evaluation target person, includes first document data which is written by the first evaluation target person,
the information, which is generated according to the activity of the second evaluation target person, includes second document data which is written by the second evaluation target person,
the first feature vector generating unit generates a feature vector with regard to a predetermined word included in the first document data, as the first data, and
the second feature vector generating unit generates a feature vector with regard to a predetermined word included in the second document data, as the second data.

14. The evaluation apparatus according to claim 11, wherein
the information, which is generated according to the activity of the first evaluation target person, includes first document data which is written by the first evaluation target person,
the information, which is generated according to the activity of the second evaluation target person, includes second document data which is written by the second evaluation target person,
the first feature vector generating unit generates a feature vector with regard to a predetermined word included in the first document data, as the first data, and
the second feature vector generating unit generates a feature vector with regard to a predetermined word included in the second document data, as the second data.

15. The evaluation apparatus according to claim 9, wherein
the information, which is generated according to the activity of the first evaluation target person, is data including, at least, a first activity record of the first evaluation target person, and
the information, which is generated according to the activity of the second evaluation target person, is data including, at least, a second activity record of the second evaluation target person.

16. The evaluation apparatus according to claim 10, wherein
the information, which is generated according to the activity of the first evaluation target person, is data including, at least, a first activity record of the first evaluation target person, and
the information, which is generated according to the activity of the second evaluation target person, is data including, at least, a second activity record of the second evaluation target person.

17. The evaluation apparatus according to claim 6, wherein
the information, which is generated according to the activity of the first evaluation target person, is data including, at least, a first activity record of the first evaluation target person, and
the information, which is generated according to the activity of the second evaluation target person, is data including, at least, a second activity record of the second evaluation target person.

18. The evaluation apparatus according to claim 5, wherein
the condition determining unit determines a learning parameter as the condition, the learning parameter being generated by executing machine learning with regard to a relation between the first feature vector and the evaluation value of each first evaluation target person.

19. An evaluation method for evaluating an evaluation target person, comprising:
determining a condition for associating a first data and an evaluation value, on the basis of the first data which includes a feature quantity of information generated according to an activity of a first evaluation target person, and the evaluation value of each first evaluation target person; and
calculating an evaluation value of a second evaluation target person, on the basis of second data which includes a feature quantity of information generated according to an activity of the second evaluation target person, and the condition determined.

20. An evaluation system for evaluating an evaluation target person, comprising:
a condition determining means for determining a condition for associating a first data and an evaluation value, on the basis of the first data that includes a feature quantity of information generated according to an activity of a first evaluation target person, and the evaluation value of each first evaluation target person; and
an evaluation means for calculating an evaluation value of a second evaluation target person, on the basis of second data which includes a feature quantity of information generated according to an activity of the second evaluation target person, and the condition determined by the condition determining means.
